(19) United States
(12) Patent Application Publication
(10) Pub. No.: US 2016/0330417 A1
(43) Pub. Date: Nov. 10, 2016

(54) REAL-TIME DATA DISPLAY DEVICE FOR BICYCLES

(71) Applicant: CONARY ENTERPRISE CO., LTD., TAIPEI CITY 10489 (TW)

(72) Inventors: WEN-WEI LIN, TAIPEI CITY 10489 (TW); HSIEN-CHENG YEN, TAIPEI CITY 10489 (TW)

(21) Appl. No.: 15/097,592

(22) Filed: Apr. 13, 2016

(30) Foreign Application Priority Data
May 6, 2015 (TW) 104206870

(51) Int. Cl. H04N 9/31; B62J 6/00; H04B 1/04; H04W 4/00; H04B 1/16

(52) U.S. Cl. CPC H04N 9/312; H04N 9/3129; H04N 9/3161; H04W 4/008; H04B 1/16; H04B 1/04; B62J 6/005; B62J 6/003; B62J 2006/008

(57) ABSTRACT

A real-time data display device for bicycles has a mobile electronic device communicates with an image projection device to transmit real-time data by having a MEMS oscillatory mirror simultaneously operating with a laser diode emitting laser beams, so as to project a real-time image with data to the ground ahead. Information such as calories, distance, time, and navigation can be acquired by the rider and other road users are easily aware of the rider to ensure safety concerns.

### BACKGROUND OF THE INVENTION

1. Field of the Invention

The invention relates to real-time data display device for bicycles, particularly to one that can project real-time data images to the ground for its riders.

2. Description of the Related Art

As people getting more and more aware of environmental issues, bicycles begin to take its place among the choices for transportation. Therefore, safety in riding bicycles is getting more and more attention as well. There are many different products of warning lights for bicycles on the markets, some of which can even project warning signs for the riders. Such products are designed to be installed to vehicles for both lighting and warning functions. Products with such features can be found in Taiwanese Patent Applications Publication No. M490434 and M392102.

FIG. 1 is a schematic diagram of an intelligent light 10 for vehicles disclosed in Taiwanese Patent Application Publication No. M490434. The device can project lights IB and a warning sign AP toward the front of a vehicle 11, so as to light up the roads ahead and to remind other road users for better safety. FIG. 2 shows a structure of a lighting projector 20 to be installed on a vehicle disclosed in Taiwanese Patent Application Publication No. M392102. It has a housing 21 with a space 22 to dispose a projection module 23 therein that includes a lighting source 231, a slide 232 with a warning sign, a biconvex lens 233, and a plane-convex lens 234. When the lighting source 231 emits lights from the housing 21, the light goes through the slide 232 and projects the warning sign thereon to the ground toward the front.

Such devices have limitation of spaces and therefore only a single warning sign can be projected statically, resulting in ineffective warning. Also, such devices cannot provide any other information for its riders during the riding.

### SUMMARY OF THE INVENTION

It is a primary object of the present invention to provide a real-time data display device for bicycles that has a mobile electronic device to communicate with a real-time projection device to project real-time data images to the ground ahead to improve problems of a single sign of warning and static projection with features of intelligence, expandability and safety.

In order to achieve the objects above, the present invention comprises a mobile electronic device and a real-time projection device.

The mobile electronic device includes a first controller; a first storage unit coupled to said first controller to store and operate an application program data for real-time data display; a display unit coupled to said first controller to display real-time data images; and a first communication unit coupled to said first controller for transmission of the real-time data.

The real-time projection device projecting images of real-time data of bicycles from said mobile electronic device includes a housing engaging a front frame of a bicycle, including a light emitting hole arranged through a surface thereof; a second controller disposed in said housing; a second communication unit coupled to said second controller in said housing for receiving real-time data from the mobile electronic device; an image processor coupled to said second controller in said housing for processing real-time data transmitted from the mobile electronic device; and converting the data into pixel information; a switch coupled to said second controller in said housing for activating the second controller; a driving circuit coupled to said second controller in said housing for transmitting the pixel information thereto after processed by the image processor; and a laser scanner disposed inside the housing correspondingly to the light emitting hole for projection, including: a laser diode coupled to the driving circuit to convert the pixel information into corresponding laser beams; a collimator disposed in front of the laser diode to project parallel laser beam therethrough; a MEMS oscillatory mirror disposed in front of the collimator for the laser beam to be thereon and reflected therefrom, to linearly scan the pixel information with simple harmonic motion after the laser beam being reflected; and an optical lens disposed correspondingly to the reflected laser beam by the MEMS oscillatory mirror for the pixel information to be converted into real-time data for projection via the optical lens.

Furthermore, the MEMS oscillatory mirror includes a driver IC and a controller; the controller holds control of driving signals from the driver IC to correspond to signals from the laser beam from the MEMS oscillatory mirror to simultaneously oscillate in two-dimension and receive the signals. The image processor further includes a register for temporary storage of pixel information. The optical lens is either a fθ lens or a f sin θ lens.

With reference to the structure disclosed above, the first communication unit is a first port and the second communication unit is a second port connecting to the first port by a transmission cable for communication; or the first communication unit is a wireless receiver and the second communication unit is a wireless transmitter for wireless connection thereto. The wireless transmitter and wireless receiver can be Bluetooth transmitter and Bluetooth receiver.

Additionally, the housing has an engaging portion for the present invention to be disengaged easily from a vehicle.

In the present invention, the real-time data includes calories, distance, time, and navigation information. The mobile electronic device further includes a first supply unit coupled to the first controller for power supply and the real-time projection device further includes a second supply unit coupled to the second controller and the laser diode for power supply. The mobile electronic device can be a smartphone, a pad, an iPod, or a PDA.

As stated above, the present invention allows a rider to easily access to the application program via the mobile electronic device. The application program can expand real-time information and transmit the data to the real-time projection device, then project the data image to the ground ahead and deliver dynamic warning signs, featuring intelligence, expandability, and safety.

### BRIEF DESCRIPTION OF THE DRAWINGS

FIG. 1 is a schematic diagram of a conventional intelligent light for vehicles;

FIG. 2 is a schematic diagram illustrating a conventional structure of a projector for vehicles;

FIG. 3 is a perspective view of the present invention;

FIG. 4 is a reverse perspective view of FIG. 3;

FIG. 5 is a block diagram of a mobile electronic device connected with a real-time image projection device according to the present invention;

FIG. 5A is a schematic diagram of a laser scanner structure of the present invention; and

FIG. 6 is a practical application view of the present invention.

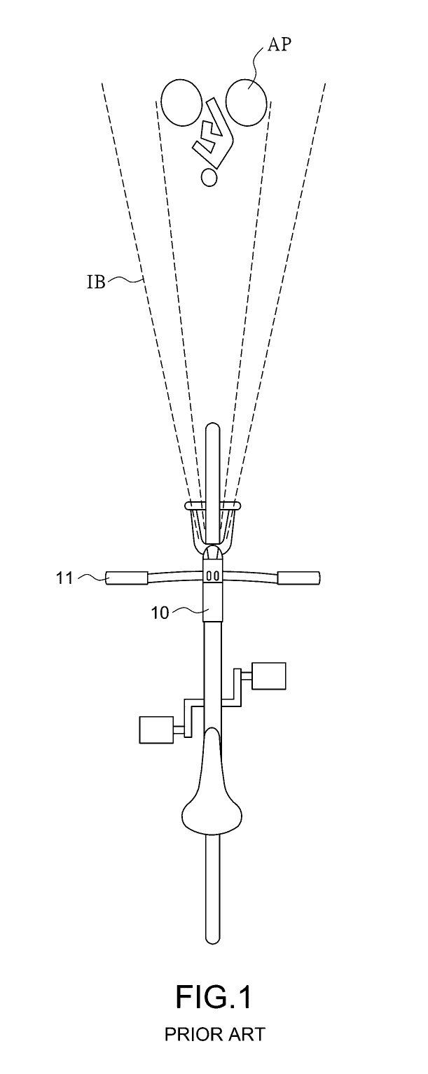

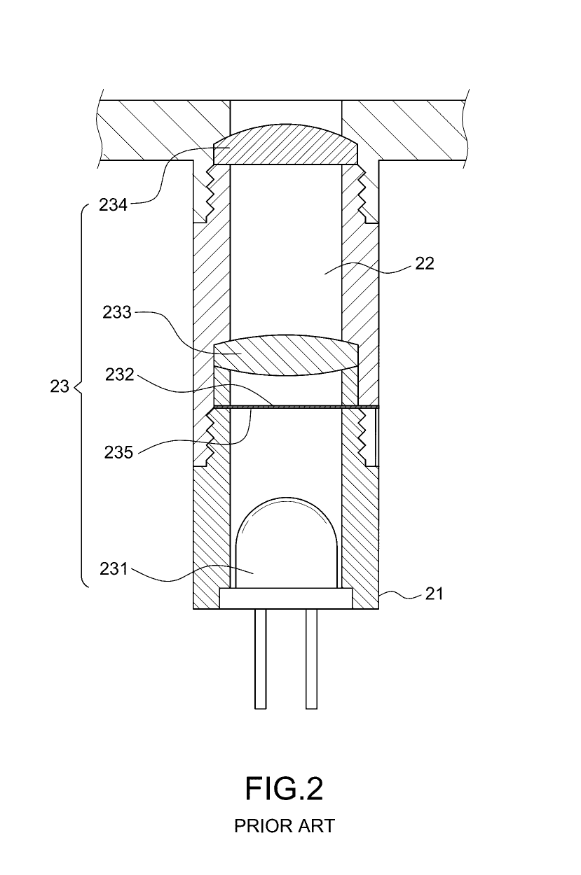

### DETAILED DESCRIPTION OF THE PREFERRED EMBODIMENT

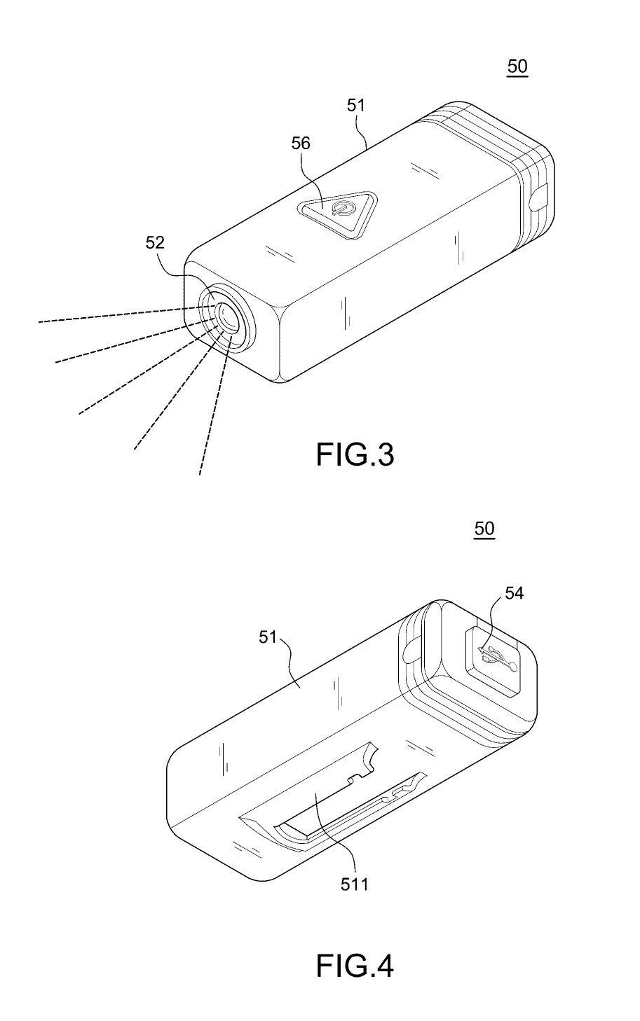

Referring to FIGS. 3-6, a preferred embodiment of the present invention, a real-time data display device for bicycles 30 mainly comprises a mobile electronic device 40 and a real-time projection device 50.

The mobile electronic device 40 includes a first controller 41, a first storage unit 42, a display unit 43, and a first communication unit 45.

The first storage unit 42 is coupled to the first controller 41 to store and operate an application program 43 for real-time data images display. In this embodiment, the real-time data includes calories, distance, time, and navigation information. The display unit 43 is coupled to the first controller 41 to display real-time data images. The first communication unit 45 is coupled to the first controller 41 for transmission of the real-time data. In this embodiment, the mobile electronic device 40 includes smartphones, pads, iPods, and PDAs, and it further includes a first supply unit 46 coupled to the first controller 41 for power supply.

The real-time projection device 50 includes a housing 51, a second controller 53, a second communication unit 54, an image processor 55, a switch 56, a driver circuit 57, and a laser scanner 58.

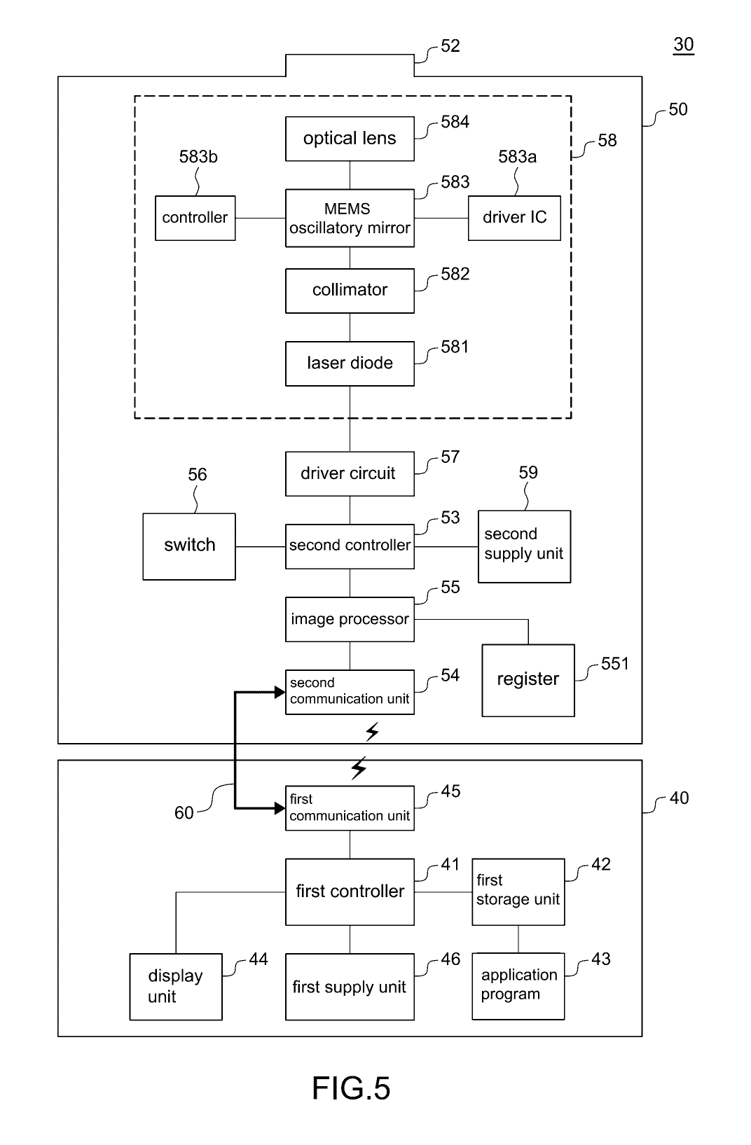

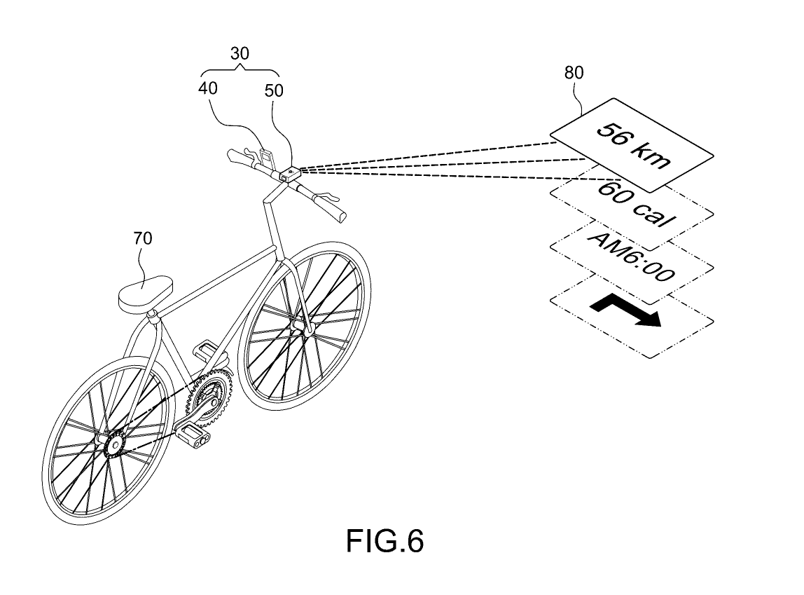

The housing 51 engages a front frame of a bicycle and includes a light emitting hole 52 arranged through a surface thereof to communicate with the mobile electronic device 40 and project images of real-time data therefrom. Referring to FIGS. 4 and 6, in this embodiment, the housing 51 further has an engaging portion 511 for the real-time data display device 30 to be disengaged easily from the bicycle.

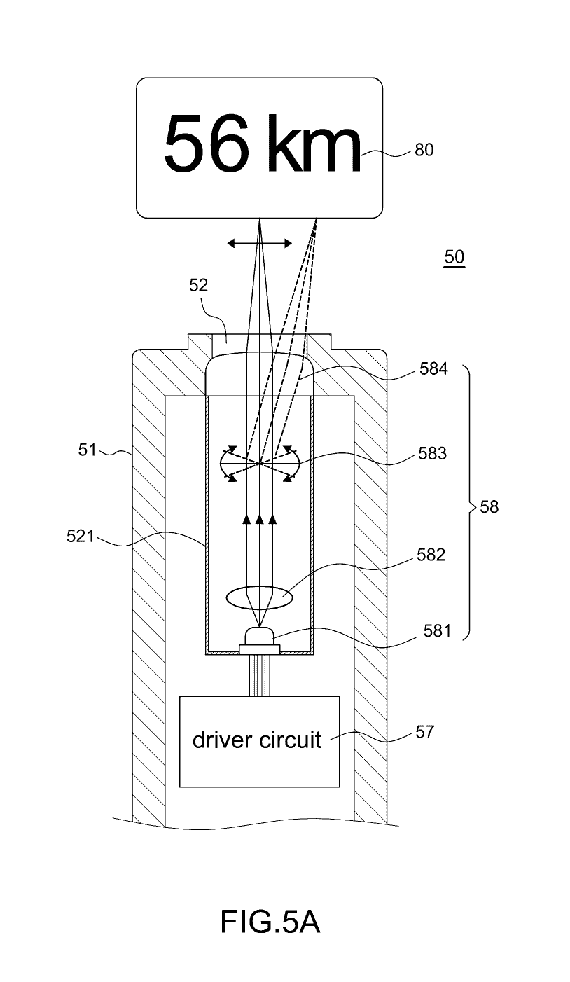

The second controller 53 is disposed in the housing. The second communication unit 54 is coupled to the second controller 53 for receiving real-time data from the mobile electronic device 40. In the block diagram shown in FIG. 5, the first communication unit 45 is a first port and the second communication unit 54 is a second port connecting to the first port by a transmission cable 60 for communication; Or the first communication unit 45 can be a wireless receiver and the second communication unit 54 can be a wireless transmitter for wireless connection thereto. In another embodiment, the wireless transmitter and wireless receiver are Bluetooth transmitter and Bluetooth receiver.

The image processor 55 is coupled to the second controller 53 for processing real-time data transmitted from the mobile electronic device 40 and converting the data into pixel information. In this embodiment, the image processor 55 further includes a register 551 for temporary storage of pixel information such as calories, distance, time, and navigation. The switch 56 is coupled to the second controller 53 in the housing 51 for activating the second controller 53. The driving circuit 57 is coupled to the second controller 53 for transmitting the pixel information thereto after processed by the image processor 55.

The laser scanner 58 is disposed inside the housing 51 correspondingly to the light emitting hole 52 for projection. With reference to FIGS. 5 and 5A, the laser scanner 58 includes a laser diode 581, a collimator 582, a MEMS oscillatory mirror 583, and an optical lens 584.

The laser diode 581 is coupled to the driving circuit 57 to convert the pixel information into corresponding laser beams. The collimator 582 is disposed in front of the laser diode 581 to project parallel laser beam therethrough. The MEMS oscillatory mirror 583 is disposed in front of the collimator 582 for the laser beam to be thereon and reflected therefrom, to linearly scan the pixel information with simple harmonic motion after the laser bean being reflected. In this embodiment, the MEMS oscillatory mirror 583 includes a driver IC 583a and a controller 583b. The controller 583b holds control of driving signals from the driver IC 583a to corresponds to signals from the laser beam from the MEMS oscillatory mirror 583 to simultaneously oscillate in two-dimension and receive the signals.

The optical lens 584 is disposed correspondingly to the reflected laser beam by the MEMS oscillatory mirror 583 for the pixel information to be converted into real-time data for projection therefrom. In this embodiment, the optical lens 584 is either a fθ lens or a f sin θ lens, and the real-time projection device 50 further includes a second supply unit 59 coupled to the second controller 53 and the laser diode 581 for power supply.

As shown in FIG. 5A, the laser scanner 58 has a small volume for conveniently disposition in the housing 51. In an applicable embodiment, the optical lens 584 and the laser diode 581 can be respectively disposed at a front and rear of a tube 521, and the collimator 582 and the MEMS oscillator mirror can be disposed in-between, forming a module with electrical connection with the driver circuit 57.

FIG. 6 is a practical application view of the present invention. Upon activating the application program 43 installed in the mobile electronic device 40, the real-time data is transmitted to the real-time projection device 50 to temporarily save the data in the register 551 of the processor 55. With the MEMS oscillator mirror 583 simultaneously conducting simple harmonic motion in two-dimension and reflecting the laser beam, the real-time data in the register 551 is thereby linearly scanned to be converted into images with data, which may contain information of calories, distance, time, or navigation guides to be projected to the ground ahead. A rider is able to switch to different images with data simply by the mobile electronic device 40 and to set up the projection period for the data images.

With the structures disclosed above, the present invention is able to intelligently control the real-time data image projection to the ground ahead and thereby improve problems of single warning sign and static projection with other features of intelligence, expandability and safety.

What is claimed is:

1. A real-time data display device for bicycles, comprising a mobile electronic device and a real-time projection device;
said mobile electronic device including:
a first controller;
a first storage unit coupled to said first controller to operate an application program and store the data thereof for real-time data display;
a display unit coupled to said first controller to display real-time data images; and
a first communication unit coupled to said first controller for transmission of the real-time data;
said real-time projection device projecting images of real-time data of bicycles from said mobile electronic device, including:
a housing engaging a front frame of a bicycle, including a light emitting hole arranged through a surface thereof;
a second controller disposed in said housing;
a second communication unit coupled to said second controller in said housing for receiving real-time data from the mobile electronic device;
an image processor coupled to said second controller in said housing for processing real-time data transmitted from the mobile electronic device; and converting the data into pixel information;
a switch coupled to said second controller in said housing for activating the second controller;
a driving circuit coupled to said second controller in said housing for transmitting the pixel information thereto after processed by the image processor; and
a laser scanner disposed inside the housing correspondingly to the light emitting hole for projection, including:
a laser diode coupled to the driving circuit to convert the pixel information into corresponding laser beams;
a collimator disposed in front of the laser diode to project parallel laser beam therethrough;
a MEMS oscillatory mirror disposed in front of the collimator for the laser beam to be projected thereon and reflected therefrom, to linearly scan the pixel information with simple harmonic motion after the laser bean being reflected; and
an optical lens disposed correspondingly to the reflected laser beam by the MEMS oscillatory mirror for the pixel information to be converted into real-time data for projection via the optical lens.

2. The real-time data display device for bicycles as claimed in claim 1, wherein the MEMS oscillatory mirror includes a driver IC and a controller; the controller holding control of driving signals from the driver IC to corresponds to signals from the laser beam from the MEMS oscillatory mirror to simultaneously oscillate in two-dimension and receive the signals.

3. The real-time data display device for bicycles as claimed in claim 1, wherein the image processor further includes a register for temporary storage of pixel information.

4. The real-time data display device for bicycles as claimed in claim 1, wherein the first communication unit is a first port and the second communication unit is a second port connecting to the first port by a transmission cable for communication.

5. The real-time data display device for bicycles as claimed in claim 1, wherein the first communication unit is a wireless receiver and the second communication unit is a wireless transmitter for wireless connection thereto.

6. The real-time data display device for bicycles as claimed in claim 5, wherein the wireless transmitter and wireless receiver are Bluetooth transmitter and Bluetooth receiver.

7. The real-time data display device for bicycles as claimed in claim 1, wherein the optical lens is either a fθ lens or a f sin θ lens.

8. The real-time data display device for bicycles as claimed in claim 1, wherein the real-time data includes calories, distance, time, and navigation information.

9. The real-time data display device for bicycles as claimed in claim 1, wherein the mobile electronic device further includes a first supply unit coupled to the first controller for power supply and the real-time projection device further includes a second supply unit coupled to the second controller and the laser diode for power supply.

10. The real-time data display device for bicycles as claimed in claim 1, wherein the mobile electronic device includes smartphones, pads, iPods, and PDAs.
